(19) United States
(12) Patent Application Publication
(10) Pub. No.: US 2015/0221940 A1
(43) Pub. Date: Aug. 6, 2015

(54) CATHODE ACTIVE MATERIAL FOR NONAQUEOUS ELECTROLYTE SECONDARY BATTERY, METHOD OF PRODUCING THE CATHODE ACTIVE MATERIAL, AND NONAQUEOUS ELECTROLYTE SECONDARY BATTERY

(71) Applicant: DENSO CORPORATION, Kariya-city (JP)

(72) Inventors: Yuta SHIMONISHI, Chita-gun (JP); Syuuhei YOSHIDA, Tokoname-city (JP)

(21) Appl. No.: 14/607,403

(22) Filed: Jan. 28, 2015

(30) Foreign Application Priority Data
Jan. 31, 2014 (JP) 2014-017582

(51) Int. Cl. H01M 4/505; H01M 4/62; H01M 4/48; H01M 4/36; H01M 4/485

(52) U.S. Cl. CPC H01M 4/505; H01M 4/366; H01M 4/485; H01M 4/483; H01M 4/625; H01M 10/0525

(57) ABSTRACT

A cathode active material for a nonaqueous electrolyte secondary battery includes a core part and a shell part arranged to a surface of the core part. The core part includes an inorganic oxide having a polyanion structure. The inorganic oxide is LiₓMn_{y}M_{1-y}XO₄, in which M is at least one of Co, Ni, Fe, Cu, Cr, Mg, Ca, Zn, and Ti, X is at least one of P, As, Si, and Mo, and 0≦x<1.0 and 0.5≦y≦1.0. The inorganic oxide has a maximum mass change ratio G1 in a temperature range from a room temperature to 250° C. when heated under inert atmosphere, and has a maximum mass change ratio G2 in a temperature range from 350° C. to 500° C. when heated under inert atmosphere. A difference between the maximum mass change ratio G2 and the maximum mass change ratio G1 is less than or equal to 5%.

### CROSS REFERENCE TO RELATED APPLICATION

This application is based on Japanese Patent Application No. 2014-17582 filed on Jan. 31, 2014, the disclosure of which is incorporated herein by reference in its entirety.

### TECHNICAL FIELD

The present disclosure relates to a cathode active material for a nonaqueous electrolyte secondary battery, a method of producing the cathode active material, and a nonaqueous electrolyte secondary battery.

### BACKGROUND

A capacity of a nonaqueous electrolyte secondary battery such as lithium-ion secondary battery largely depends on the kind of cathode active material which electrochemically inserts or removes metal ion such as lithium ion. Inorganic powder of oxide such as LiCoO₂ and LiMn₂O₄ is used as the cathode active material.

Since capacity, battery voltage, input-and-output characteristic, safety, and the like changes according to the kind of cathode active material, the cathode active material is properly used depending on the use of battery. The structure of cathode active material is stable, that has a polyanion structure including XO₄ tetrahedron (X=P, As, Si, Mo, etc.) in the crystal structure. An olivine structure such as LiFePO₄ is one of the polyanion structures, and a nonaqueous electrolyte secondary battery uses an olivine-base material that has the olivine structure.

However, electric conduction rate (easiness for electricity to flow on the material surface) and Li diffusion coefficient (easiness for Li ion to move inside the material) of the olivine material such as LiFePO₄ are orders of magnitude smaller as compared with LiCoO₂ or LiMn₂O₄, because the material resistance is large.

In order to improve the electric conduction rate, a synthetic method is known in which the surface is covered with carbon.

In order to improve the diffusibility of Li, the size of particle is made minute, for example, the diameter of the particle is made into a nanometer order. There are synthetic methods for making the olivine-base material minute.

For example, carbon is mixed into raw material The olivine-base material is made minute using the chemical-reduction reaction caused by the carbon, or the carbon becomes a core of an output production.

Moreover, a production method is proposed based on a chemical reaction of FePO₄+0.5Li₂CO₃+0.5C→LiFePO₄+0.5CO₂+CO, in which the amount of carbon input when the raw materials are mixed is made larger than the amount of carbon which should be contained in a final product. That is, carbon is used as a chemically-reducing agent to accelerate the reaction such that the particle growth is restricted.

An olivine-base material LiFePO₄ is applicable to a cathode material, and it is required to further raise the electric potential in case the cathode material is applied to, for example, a plug-in hybrid vehicle (PHV) in which a predetermined energy density is needed.

The cathode potential is determined by a transition metal used, theoretically. If Fe of LiFePO₄ is replaced with Mn, LiMnPO₄ may achieve higher electric potential.

The electric conduction rate and the Li diffusion coefficient of LiMnPO₄ is much lower as compared with LiFePO₄, and it is required to further make the carbon coat uniform and to further make the particles minute. The above-described synthetic method is aimed to produce mainly LiFePO₄. In case where the above-described synthetic method is applied to produce LiMnPO₄, the primary particle is larger, and the uniformity of carbon coat is lowered, compared with a case of LiFePO₄.

When the mixing and the reaction of materials are insufficient in the manufacturing of LiFePO₄, Li₃PO₄ and Li₂CO₃ remain as impurities. JP 2009-32656A (US 2008/0222881) describes a method of removing the impurities by washing with pH buffer solution.

However, a cathode active material in which Mn is indispensable, such as LiMnPO₄, contains impurities generated by a different mechanism from LiFePO₄, and the impurities may not be removed by simply washing with pH buffer solution.

### SUMMARY

It is an object of the present disclosure to provide a cathode active material for a nonaqueous electrolyte secondary battery, that has a polyanion structure such as Mn-indispensable olivine structure, in which impurities are removed to achieve high performance, a method of producing the cathode active material, and a nonaqueous electrolyte secondary battery including the cathode active material.

By tracing the reaction mechanism of LiMnPO₄ in detail, a specific reaction which is not recognized in the synthetic process of LiFePO₄ is found out. In the reaction process of LiMnPO₄, Mn²⁺ forms Mn-base chemical intermediate that is a hydrate consisting of Mnₓ(PO₄)_{y}(H₂O)_{z}. Since the core growth is advanced in the intermediate, impurities derived from Mn or Li compound are generated in LiMnPO₄.

The impurities originating from the intermediate remain in the manufactured cathode active material, and not only lowers the conductivity but lowers the durability relative to high temperature because they are eluted under high temperature situation to generate gas.

The impurities in the cathode active material having the polyanion structure containing Mn, such as LiMnPO₄, are originated in the characteristic of the electron orbit of Mn. The 3d orbit of Mn²⁺ is stable due to the half-closed shell, and the Mn intermediate does not have a valence modification at the synthetic reaction time of LiMnPO₄. Therefore, the Mn intermediate grows and the generation of LiMnPO₄ becomes slow that is achieved by the attack of Li ion to the Mn intermediate.

In order to advance the reaction to generate LiMnPO₄, long time reaction or reaction under high temperature is needed. In the case of long time reaction, the Mn intermediate further grows and remains as impurities. In the case of reaction under high temperature, the Mn intermediate and the generated LiMnPO₄ are monotectoid (segregation) and the impurities caused by a deviation between an ideal value and an actual value increase. Furthermore, the Mn intermediate with insufficient reaction may remain in the output product.

In a conventional method of chemically synthesizing LiMnPO₄, pH change arises at the time of reaction such that the Mn intermediate is notably generated.

On the other hand, since the orbit of Fe²⁺ is not half-closed shell in LiFePO₄, a valence modification is caused to generate stable Fe³⁺ that is half-closed shell. Therefore, at the time of the synthetic reaction of LiFePO₄, Fe intermediate has a valence modification from 2+ to 3+, and a structural change of the intermediate resulting from the valence modification causes pulverization. The pulverization advanced in the synthetic reaction makes it easy for Li ion to attack Fe intermediate, and the chemical synthesis of LiFePO₄ advances smoothly. Therefore, impurities contained in the manufactured LiFePO₄ are only resulting from materials residual, such as Li₃PO₄ and Li₂CO₃, and the amount of impurities is small.

According to a first aspect of the present disclosure, the Mn intermediate is generated slowly by restricting the pH change in the synthetic reaction by adding pH buffer solution. If pH becomes higher to some extent, the Mn intermediate is deposit. Therefore, the change in pH is restricted from exceeding a predetermined value, so as to solve the above described issues.

According to a second aspect of the present disclosure, the impurities remaining in LiMnPO₄ are removed by washing with pH buffer solution. Relative to inorganic oxide containing Mn, it is required to set a pH range which is different from that for Li₃PO₄ or Li₂CO₃ generated at the synthetic time of LiFePO₄.

In case where the impurities remaining in LiMnPO₄ are removed by washing with water, similarly to the case of LiFePO₄, in the synthetic process, the remaining Li is dissolved to cause alkali atmosphere due to the polarity of water. In this case, not only Mn hydrate impurities but bulk composition that should not be dissolved are eluted by washing with water.

As explained above, the present disclosure is based on analysis of action of Mn hydrate or Li compound which inevitably remains in the synthetic process of LiMnPO₄. In the synthetic process of manganese phosphate hydrate, buffer solution is added to raw materials slurry to restrict pH change at the reaction time and to restrict deposit of impurities (according to the first aspect of the present disclosure), or the washing process is applied by solution having buffer action (according to the second aspect of the present disclosure). Thus, it becomes possible to reduce the impurities without affecting the bulk composition of LiMnPO₄.

In addition, the present disclosure is aimed to solve a subject issue peculiar to the atomic orbital of Mn, and can be applied to a polyanion material having other XO₄ tetrahedron structure using Mn element without limited to the olivine material.

According to the present disclosure, a cathode active material for a nonaqueous electrolyte secondary battery includes: a core part including an inorganic oxide having a polyanion structure, to which a carbon composite is possible; and a shell part arranged to a surface of the core part, the shell part having carbon. The inorganic oxide is LiₓMn_{y}M_{1-y}XO₄, in which M is at least one of Co, Ni, Fe, Cu, Cr, Mg, Ca, Zn, and Ti, X is at least one of P, As, Si, and Mo, and 0≦x<1.0 and 0.5≦y≦1.0. The inorganic oxide has a maximum mass change ratio G1 in a temperature range from a room temperature to 250° C. when heated under inert atmosphere. The inorganic oxide has a maximum mass change ratio G2 in a temperature range from 350° C. to 500° C. when heated under inert atmosphere. A difference between the maximum mass change ratio G2 and the maximum mass change ratio G1 is less than or equal to 5%.

The inventors succeed in reducing the remaining amount of the impurities originating from the intermediate etc. by devising the production method of LiMnPO₄, so as to offer new and high-performance nonaqueous electrolyte secondary battery.

The definition of “inert atmosphere” will be specifically described below in this specification, which is a condition under which the maximum mass change ratio G1 and the maximum mass change ratio G2 are measured.

The cathode active material that is produced as mentioned later for a nonaqueous electrolyte secondary battery has little amount of intermediate of hydrate in the production process, and has little amount of impurities originated from hydrate in the finally manufactured product.

The amount of impurities originated from hydrate increases or decreases in relation to the value of the difference G2−G1 mentioned above. The maximum mass change ratio G1 that is decreased to the temperature of 250° C. mainly originates in water adhering to the surface. The maximum mass change ratio G2 that is decreased between 350° C. and 500° C. originates in crystal water.

The production method of the cathode active material has two aspects that are not exclusive from each other, and the combination of the two aspects is possible.

A method (first aspect) A includes an inorganic oxide composition process in which the above-mentioned inorganic oxide is synthesized under the situation within pH buffer solution. The inorganic oxide which is a base component of a cathode active material for a nonaqueous electrolyte secondary battery is synthesized under existence of pH buffer solution, such that a desirable synthetic speed of intermediate can be obtained. As a result, the manufactured cathode active material for a nonaqueous electrolyte secondary battery can achieve high performance.

After the inorganic oxide is synthesized, pH of the slurry is set lower than or equal to 7.0 by adjusting the addition amount of pH buffer solution such that the performance can be further raised.

A method (second aspect) B includes an inorganic oxide composition process in which the synthesized inorganic oxide is washed or wet-cracked with pH buffer solution. The residual amount of impurities can be reduced by washing the synthesized compound with pH buffer solution. Moreover, the impurities remaining inside the synthesized compound are efficiently removed by the wet-cracking.

In the production method, only the reaction advancing under existence of moisture is indispensable relative to the method A, and only the washing process after the synthesis is indispensable relative to the method B. For example, in the synthetic method to which the method A is applied, hydrothermal synthesis method, wet solid phase synthesis method, or coprecipitation method may be used. The synthetic method to which the method B is applied is not limited.

The pH buffer solution makes pH in the range between 4.0 and 7.0, such that the bulk composition can be less affected.

The pH buffer solution may contain Mn ion, such that elution of Mn ion can be restricted.

The pH buffer solution may contain weak acid and the sodium salt of weak acid in both the method A and the method B.

As a method C similar to the method A and the method B, pH is kept in a range higher than or equal to 4.0 and lower than or equal to 7.0 at least when synthesizing and/or washing the inorganic oxide. The same effect and advantage can be obtained as the method A and the method B by controlling pH in the range of 4.0-7.0 at a timing in the inorganic oxide composition process.

A nonaqueous electrolyte secondary battery includes the above-mentioned cathode active material.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a sectional view illustrating a coin battery according to an embodiment;

FIG. 2 is a graph explaining a relationship between temperature and mass change ratio relative to test examples;

FIG. 3 is a graph explaining a relationship between electric potential and capacity relative to test examples; and

FIG. 4 is a view explaining test examples of the embodiment and comparative example.

### DETAILED DESCRIPTION

A nonaqueous electrolyte secondary battery is a battery in which nonaqueous electrolyte is adopted as an electrolyte. Lithium ion, sodium ion, etc. is used as an electrolytic ion. The secondary battery is charged and discharged by movement of electric charge accompanying transfer of the electrolytic ion between a positive pole (cathode) and a negative pole (anode). A secondary battery such as lithium ion battery, secondary lithium-ion battery, lithium-polymer battery, lithium-air battery, and lithium-sulfur battery is included in the nonaqueous electrolyte secondary battery.

An active material means a substance (compound) participating in accumulation of electricity on the cathode side or anode side. That is, an active material participates in electron absorption and emission at a time of charging and discharging the battery.

An cathode active material, a production method of the cathode active material, and a nonaqueous electrolyte secondary battery including the cathode active material are not limited to the following embodiment. Changes and modifications are to be understood as being within the scope of the present disclosure as defined by the appended claims.

A battery is described in the following embodiment in which lithium ion is adopted. Alternatively, other ion such as sodium ion may be adopted to a cathode active material having the polyanion structure containing Mn.

The cathode active material for a nonaqueous electrolyte secondary battery has a core shell structure including a core part and a shell part. The core part has polyanion-structured inorganic oxide to which a carbon composite is possible. In other words, the inorganic oxide includes an inorganic compound oxide to which carbon is compounded.

The shell part is arranged to the surface of the core part so as to cover the core part. A mass ratio between the core part and the shell part is not limited. For example, the mass ratio between the core part and the shell part may be in a range from about 99:1 to about 90:10. The shell part includes carbon. Carbon includes a carbon material which may be a single substance of carbon, and it is desirable that carbon is the carbon material itself.

The inorganic oxide included in the core part is LiₓMn_{y}M_{1-y}XO₄, in which M is at least one selected from Co, Ni, Fe, Cu, Cr, Mg, Ca, Zn, and Ti, X is at least one selected from P, As, Si, and Mo, and 0≦x<1.0 and 0.5≦y≦1.0. If y is 1, the inorganic oxide does not contain M, and has the polyanion structure. The inorganic oxide may be an olivine material with an olivine structure. The core part may contain materials other than the inorganic oxide with the polyanion structure, such as a compound which can be used for a nonaqueous electrolyte secondary battery.

When the inorganic oxide is heated under an inert atmosphere, the inorganic oxide has a maximum mass change ratio G1 in a temperature range from a room temperature to 250° C., and the inorganic oxide has a maximum mass change ratio G2 in a temperature range from 350° C. to 500° C. A difference between the maximum mass change ratio G1 and the maximum mass change ratio G2 is smaller than or equal to 5% (G2−G1≦5%). The difference between the maximum mass change ratio G1 and the maximum mass change ratio G2 may be smaller than or equal to 4%. The difference between the maximum mass change ratio G1 and the maximum mass change ratio G2 may be smaller than or equal to 3%. The difference between the maximum mass change ratio G1 and the maximum mass change ratio G2 may be smaller than or equal to 0%. The difference between the maximum mass change ratio G1 and the maximum mass change ratio G2 may be smaller than or equal to −1%. The difference between the maximum mass change ratio G1 and the maximum mass change ratio G2 may be smaller than or equal to −3%.

The mass change is measured while heated from room temperature (25° C.) to 500° C. at a temperature raising speed of 1° C./minute under inert atmosphere (such as nitrogen gas) as the heating condition. The difference between a mass measured before the heating (100%) and a mass measured from 25° C. to 250° C. is calculated, and the largest value of the absolute value of the calculated difference is defined as G1. The largest value of the absolute value of a difference calculated between a mass measured before the heating (100%) and a mass measured from 350° C. to 500° C. is defined as G2. The value of G2−G1 is calculated by subtracting the value G1 from the value G2.

The diameter of the particle of the cathode active material for a nonaqueous electrolyte secondary battery is not limited. For example, the volume average diameter of a primary particle is in a range between 30 nm and 200 nm, and the volume average diameter of a secondary particle is in a range between 0.5 micrometer and 40 micrometers.

The production method of the cathode active material has a process of forming the core part, and a process of forming the shell part, so as to produce the above-described cathode active material for a nonaqueous electrolyte secondary battery.

The process of forming the core part includes synthesizing an inorganic oxide, in which at least one of a method A and a method B is applied. Moreover, a method C is also employable.

The synthetic method of inorganic oxide is not limited. For example, a hydrothermal synthesis method, a wet solid phase synthesis method, a coprecipitation method, or the like can be used. Generally, materials including elements according to the composition of the inorganic oxide are mixed for the synthesizing. For producing LiₓMn_{y}M_{1-y}XO₄, the source of Li, the source of Mn, the source of M, and the source of X are mixed at a proper ratio (for example, the same ratio as the composition ratio), and synthetic reaction is performed. If carbon is compounded, the source of carbon is also mixed. The sources may be salt (sulfate etc.) or oxide containing the elements contained in the inorganic oxide. The source of carbon is a compound carbonized by calcination. For example, the source of carbon is a highly polymerized compound such as soluble cellulose (carboxymethyl cellulose; CMC) or synthetic polymers (polyvinyl alcohol; PVA).

After forming the core part, the core part is burned with the source of carbon to arrange the shell part on the surface of the core part. The source of carbon may be polysaccharides such as CMC or synthetic polymers such as PVA. Calcination is performed under inactive atmosphere or under reduction atmosphere (hydrogen etc.) not to oxidize carbon contained in the source of carbon. The temperature of the calcination is not limited. For example, the calcination is performed in a temperature range between 500° C. and 800° C.

The method A includes an inorganic oxide composition process in which the inorganic oxide is synthesized under existence of pH buffer solution. The pH buffer solution is a water solution, and this process is applicable to the hydrothermal method, in which water is indispensable for synthesizing the inorganic oxide, wet solid phase synthesis, coprecipitation method, sol gel process, and the like. The hydrothermal method may be a desirable method, in which materials are dissolving in water and heated, preferably under high temperature and high pressure situation.

The pH buffer solution may include weak acid and weak acid salt such as sodium, lithium, or potassium. For example, sodium salt is desirable as the weak acid salt. The weak acid may be citric acid, NaHCO₃, NaH₂PO₄, acetic acid, formic acid, tartaric acid, and the like.

The kind and the addition amount of the pH buffer solution are determined such that pH of the slurry is lower than or equal to 7.0 after the end of synthetic reaction. Moreover, pH of the slurry after the reaction is desirably higher than or equal to 4.0. Mn can be securely held to the generated inorganic oxide when pH of the slurry is higher than or equal to 4.0. When pH of the slurry is lower than or equal to 7.0, generation of impurities can be effectively controlled. At the time of mixing, pH of the buffer solution is not limited. For example, pH of the buffer solution is desirably lower than or equal to 7.0.

The method B includes an inorganic oxide composition process, in which wet-cracking or washing is performed under existence of pH buffer solution, after synthesizing the inorganic oxide. The impurities generated at the synthesis time are dissolved and removed by the pH buffer solution. When the wet-cracking is performed under existence of pH buffer solution, the impurities can be effectively dissolved. The wet cracking is an operation of dispersing the secondary particles to primary particle or secondary particle with smaller diameter. The wet cracking is a single operation such as pulverization operation, mix operation or the combination thereof. An extent of the washing with pH buffer solution can be determined in consideration of the value of G2−G1.

The pH buffer solution preferably has pH lower than or equal to 7.0, and preferably has pH higher than or equal to 4.0. When pH is higher than or equal to 4.0, Mn can be securely held not to the pH buffer solution but to the inorganic oxide at the washing time. When pH is lower than or equal to 7.0, the impurities are effectively removed. It can be easily judged whether the removal of impurities is sufficient or not by measuring the value of G2−G1.

Mn ion can be contained in the pH buffer solution. Mn ion can be added to the pH buffer solution by adding Mn salt. It is desirable to add Mn ion, so that the concentration becomes more than or equal to 0.1M or becomes more than or equal to 0.15M. Mn ion restricts Mn from being eluted from the inorganic oxide into the pH buffer solution. As a result, Mn can be securely held to the inorganic oxide.

The method C is similar to the method A and the method B. In the method C, pH is kept in the range higher than or equal to 4.0 and lower than or equal to 7.0, when the inorganic oxide is synthesized and/or when the inorganic oxide is washed. At a timing in the inorganic oxide composition process, pH, is controlled in the range of 4.0-7.0, such that the same effect and advantage can be obtained as the method A and the method B. A method of controlling pH is not limited. For example, a proper quantity of acid or alkali is added according to the measured pH. Generally, pH is shifted toward alkali in the inorganic oxide composition process, so acid may be added properly.

Lithium secondary battery corresponding to a nonaqueous electrolyte secondary battery includes a cathode, an anode, a separator interposed between the cathode and the anode, a nonaqueous electrolysis solution corresponding to a nonaqueous electrolyte, a casing, and the other required components.

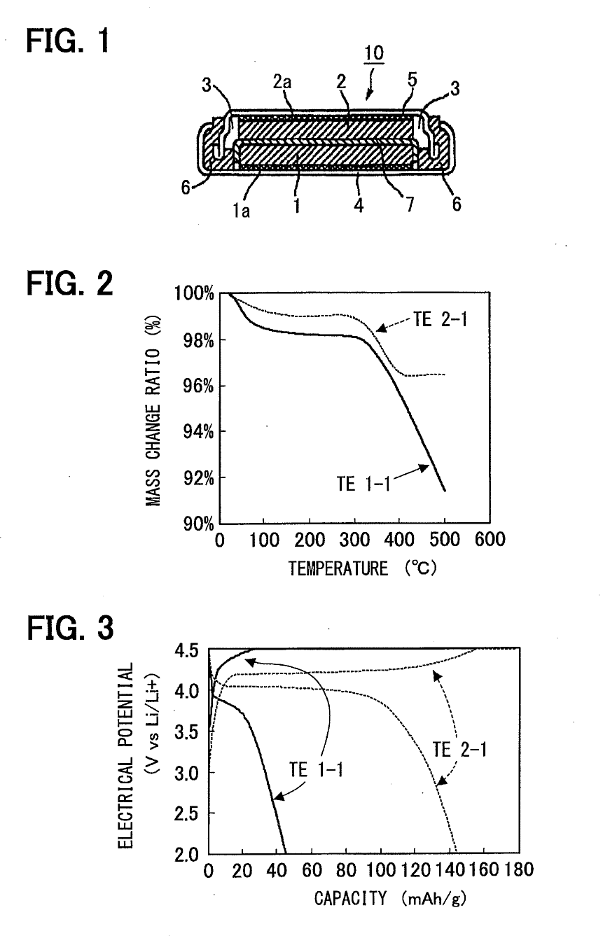

With reference to FIG. 1, a coin battery is described in this embodiment. As shown in FIG. 1, the coin battery 10 includes the cathode 1, the anode 2, the nonaqueous solvent electrolysis solution 3, the separator 7 interposed between the cathode 1 and the anode 2, the cathode case 4 and the anode case 5.

The cathode 1 has a cathode current collector. 1a and a laminated layer. The anode 2 has an anode current collector 2a and a laminated layer. The cathode case 4 and the anode case 5 respectively serve as positive pole terminal and negative pole terminal. The gasket 6 made of polypropylene is disposed between the cathode case 4 and the anode case 5 to achieve the tight sealing and the insulation between the cathode case 4 and the ANODE case 5.

The method of producing the cathode is described. The cathode active material which reversibly absorbs or desorbs lithium ion is suspended and mixed in solvent that can be applied to the cathode laminated layer constructed of the electric conduction material and the binder, so as to provide slurry. The slurry is applied to one surface or both surfaces of the current collector, and is dried, such that the cathode can be produced.

The cathode active material for a nonaqueous electrolyte secondary battery of this embodiment is indispensable as a cathode active material. If needed, general purpose cathode active material may be further mixed. For example, a variety of oxide, sulfide, lithium-included oxide, conductive polymer, etc. can be used. For example, MnO₂, TiS₂, TiS₃, MoS₃, FeS_{z}, Li₁₋ₓMnO₂, and Li₁₋ₓMn₂O₄, Li₁₋ₓCoO₂, Li₁₋ₓNiO₂, LiV₂O₃, V₂O₅, polyaniline, poly(p-phenylene), polyphenylene sulfide, polyphenylene oxide, polythiophene, polypyrrole and those derivatives, and stable radical compounds may be used. In addition, x in these cathode active materials shows the number of 0-1. Li, Mg, Al, or transition metal such as Co, Ti, Nb, Cr or the like may be added or replaced in the material. Moreover, lithium-metal composite oxide may be used solely or plural kinds of the lithium-metal composite oxides may be mixed for the use. The lithium-metal composite oxide may be preferably at least one of lithium-manganese composite oxide, lithium-nickel composite oxide, and lithium-cobalt composite oxide, that has stratified structure or spinel structure.

The electric conduction material is not limited, and is mixed if needed, as a general purpose for lithium secondary battery. For example, carbon material, metal powder, conductive polymer, etc. can be used. From a viewpoint of conductivity and stability, it may be desirable to use carbon material such as acetylene black, Ketjen black, or carbon black.

The binder is not limited as a general purpose for lithium secondary battery. For example, polytetrafluoroethylene (PTFE), polyvinylidene fluoride (PVDF), fluororesin copolymer (tetrafluoroethylene-hexafluoropropylene copolymer), styrene-butadiene rubber (SBR), acryl-base rubber, fluorine-base rubber, polyvinyl alcohol (PVA), styrene maleic acid resin, polyacrylic acid salt, carboxyl methyl cellulose (CMC), etc. can be used.

Organic solvent that dissolves the binder is generally used as the solvent in which the cathode active material etc. is suspended. For example, N-methylpyrrolidone (NMP), dimethylformamide, dimethylacetamide, methylethyl ketone, cyclohexanone, methyl acetate, methyl acrylate, diethyltriamine, N—N-dimethylaminopropylamine, ethylene oxide, tetrahydrofuran, water, etc. can be used, but not limited. Moreover, dispersing agent, thickening agent, etc. may be added to water, such that the active material is made to slurry by PTFE.

The current collector is not limited as a general purpose for lithium secondary battery. For example, highly conductive metal such as copper, aluminum, nickel, titanium, or stainless steel can be used as the main component. The shape of the current collector is not limited, according to the shape of the battery formed by the electrode, may be cylinder, tabular, foil, mesh, punching metal, expanded metal, or the like.

The method of producing the anode is described. The anode active material which reversibly absorbs or desorbs lithium ion is suspended and mixed in suitable solvent that can be applied to the anode laminated layer constructed of the electric conduction material and the binder, if needed, so as to provide slurry. The slurry is applied to one surface or both surfaces of the current collector, and is dried, such that the anode can be produced.

The anode active material contains carbon material such as hardly graphitizable carbon (hard carbon), easily graphitizable carbon (soft carbon), black lead (graphite), etc., and the graphite may be desirable. The graphite represents natural graphite, artificial graphite, and graphitization meso carbon micro bead. Further, pitch-base, polyacrylonitrile-base, meso-phase pitch-base, and vapor phase epitaxy-base graphitized carbon fiber may be processed to powder state for the use. Moreover, the single use or the combination use is possible.

The carbon material used for the anode active material is preferably surface-modified graphite in which the surface is modified. By carrying out the modification processing relative to the surface of the carbon material, the surface of the carbon material easily gets wet in electrolysis solution, and good SEI film can be formed. Therefore, high temperature cycling characteristics and energy density are improved. The method of modifying the surface of carbon material for the anode active material is not limited, for example, may be fluorine treatment, acid treatment, alkali treatment, plasma treatment, and the like.

The electric conduction material, the binder, the solvent in which the anode active material is suspended, and the current collector can be suitably chosen from what was explained for the cathode.

Nonaqueous electrolysis solution is not limited as a general purpose solution in which electrolyte is dissolved in nonaqueous solvent. For example, mixed solvent may be used with annular carbonate such as ethylene carbonate (EC), propylene carbonate (PC), or butylene carbonate (BC), and chain carbonate such as dimethyl carbonate (DMC), ethylmethyl carbonate (EMC), diethyl carbonate (DEC). Further, mixed solvent may be used with annular carbonate and ether-base solvent such as 1,2-dimethoxyethane, or 1,2-diethoxy ethane.

The electrolyte is not limited, for example, may be at least one of mineral salt chosen from LiPF₆, LiBF₄, LiClO₄, and LiAsF₆, the derivative of the mineral salt, organic salt chosen from LiSO₃CF₃, LiC(SO₃CF₃)₃ and LiN(SO₂CF₃)₂, LiN(SO₂C₂F₅)₂, LiN(SO₂CF₃)(SO₂C₄F₉), and the derivative of the organic salt. The electrolyte further improves the battery performance, and maintains the battery performance still high also in a temperature region not including the room temperature. The concentration of electrolyte is not limited and may be suitably set in consideration of the kind of electrolyte and organic solvent according to the use.

The separator electrically insulates the cathode and the anode from each other, and holds the electrolysis solution. For example, the separator may be porous synthetic resin film, especially may be porous film made of polyolefin-base polymer (polyethylene, polypropylene). The size of the separator is larger than the cathode and the anode in order to secure the insulation between the cathode and the anode.

The lithium secondary battery of the present embodiment may further include the other necessary components. The shape of the lithium secondary battery of the present embodiment is not limited, for example, may be coin shape, cylinder shape, or square shape. The casing for the lithium secondary battery is not limited, for example, may be a hard casing made of metal or resin, or a soft casing such as lamination pack.

The lithium secondary battery is activated by performing initial charge, such that conditioning is made. A condition for the initial charge is not limited, except the conditions above-described with respect to the lithium secondary battery. The charging can be performed until the potential difference between the positive pole and the negative pole reaches the maximum potential (for example, more than or equal to 4.1V) that is properly determined with the kind of active material or electrolysis solution. General charging method can be adopted such as constant current charge, constant voltage charge, and constant-current and constant-voltage charge. The initial charge may not be finished by one charging. In other words, the charging may be repeated twice or more with addition of discharging operation. In this case, lithium source can be added into the cathode for each charging. After performing the initial charge, in order to remove the gas (originated from lithium source) which exists in the battery, the inside of the battery may be made to communicate to outside, or the initial charge can be performed in the state before a sealing of the battery is performed, preferably under low humid situation.

Hereafter, the embodiment is further described relative to the cathode active material for nonaqueous electrolyte secondary battery and the production method of the cathode active material in detail. However, the following explanation does not limit the scope of the present disclosure.

The production method of the cathode active material includes an inorganic oxide composition process and the other process. The inorganic oxide composition process includes at least the following first to fifth processes. The test examples 2-1, 2-2, 2-3, 2-4, 2-5, 2-6, 2-7, 2-8, 2-9, 2-10, 2-11, 2-12, 2-13 are based on the present embodiment, and the test examples 1-1, 1-2, 1-3, 1-4, 1-5, 1-6, 1-7 are comparative examples.

### (First Process)

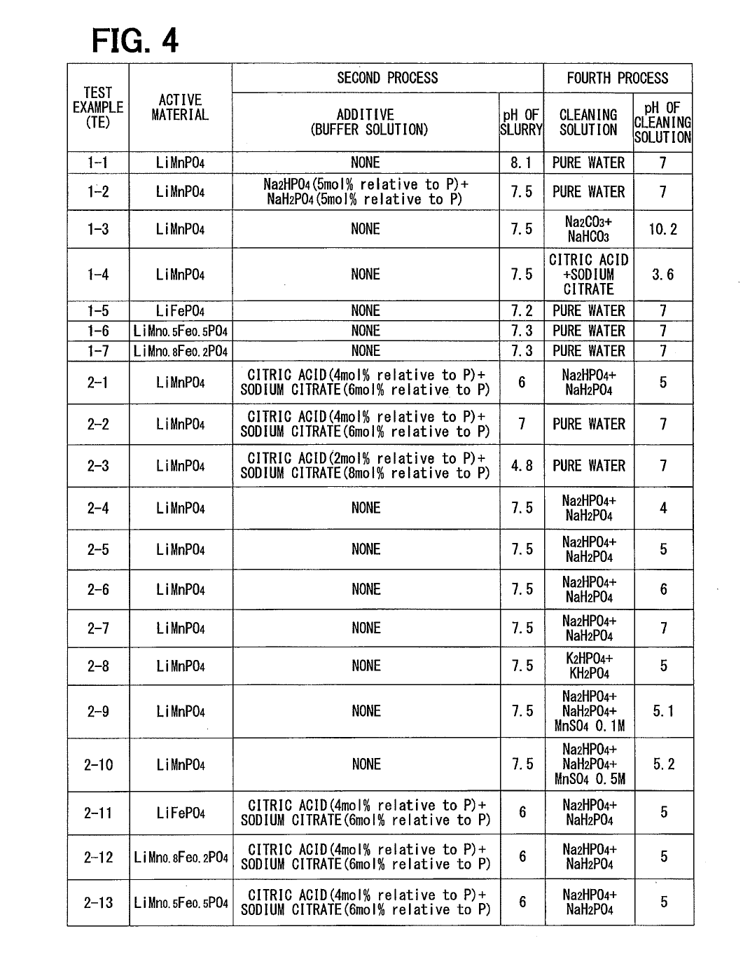

A mixture is made with the following molar ratio, Li₂SO₄ (the source of Li): MnSO₄ (the source of Mn): FeSO₄.7H₂O (the source of M (Fe)): (NH₄)₂HPO₄ (the source of X (P))=3:a:(1−a):1, in which a is larger than 0 and smaller than or equal to 1. In FIG. 4, the value of a is a numerical value indicated after Mn. Specifically, a is 0.5 in the test example 1-6 and the test example 2-13, and a is 0.8 in the test example 1-7 and the test example 2-12, in FIG. 4.

### (Second Process)

Relative to the mixture, pH buffer solution is added as shown in FIG. 4, and water is added, such that the slurry, as a whole, includes the pH buffer solution with the concentration of 0.1M.

### (Third Process)

The slurry obtained in the second process is laid under hydrothermal synthesis (180° C., 1 hour). FIG. 4 represents pH after the end of the reaction.

### (Fourth Process)

Filtration washing is performed using wash solution shown in FIG. 4. The filtration washing in this process is equivalent to a washing, and a wet-cracking also occurs in part. The amount of the washing solution is set 20 times relative to the amount of the solid content. FIG. 4 shows pH of the washing solution.

### (Fifth Process)

Vacuum drying is performed under situation of 80° C. for 10 hours, such that the core part is formed.

### (Sixth Process)

After CMC is added as the source of carbon to the theoretical yield of inorganic oxide, by only 10 mass %, calcination is performed at 700° C. for 1 hour under hydrogen gas atmosphere containing 3% Ar, such that the shell part is formed on the surface of the core part.

### (Evaluation)

In order to compute the difference G2−G1, G1 and G2 are measured using Shimadzu DTG-60H. The cathode active of 50 mg is put in a pan made of Pt, and the temperature is raised at the speed of 1° C./minute within the temperature range between 25° C. and 500° C. under nitrogen atmosphere and gas flow rate of 50 mL/minute, in which the gas introduction and the temperature raising are started simultaneously. In this method, complete replacement with nitrogen gas may not be finished immediately after the measurement is started, so residual oxygen might be contained. However, G1 and G2 are measured in this way. The measurement of G1 and G2 performed using this equipment and method in this embodiment is treated as measurement under inert atmosphere.

In case where oxygen remains immediately after the measurement is started, if the concentration of oxygen becomes lower than that of atmospheric air (if oxygen is eventually included as trace or impurities level) after that, it is supposed as inert atmosphere under which G1 and G2 are measured.

G1 is the largest value of absolute values of the difference between a base value (100%) that is the mass of 50 mg before heating and a mass measured in the range from 25° C. to 250° C. G2 is the largest value of absolute values of the difference between a base value (100%) that is the mass of 50 mg before heating and a mass measured in the range from 350° C. to 500° C. Then, the difference G2−G1 is calculated by subtracting G1 from G2. The calculated results are shown in Table A, Table B and Table C.

The mass change accompanying the temperature raising is shown in FIG. 2 relative to each of the test example 1-1 (comparative example) and the test example 2-1 (embodiment). As shown in FIG. 2, the mass reduction of the test example 2-1 in the range higher than or equal to 300° C. (that is equivalent to G2) is small, compared with the test example 1-1, because the impurities in the test example 2-1 are small (decreased compared with the comparative example). In addition, it is thought that the carbon composite hardly advances under the present condition. The carbon composite to the core part does not have big influence on the removal of impurities, since the carbon composite does not have big influence on the reaction synthesizing the inorganic oxide from the raw materials. Therefore, the similar result is to be obtained, as to the carbon-composite core part, by conducting the similar experiments.

A half cell of the nonaquaous electrolyte secondary battery is produced as follows. A solvent is provided by mixing EC, DMC and EMC with the mass ratio of EC:DMC:EMC=3:3:4. LiPF₆ is added into the solvent as electrolyte, and the nonaqueous electrolysis solution is manufactured as LiPF₆ solution of 1.0M. As an additive, vinylene carbonate is added by 2 mass %.

The cathode active material of 89 parts mass, according to the embodiment and the comparative example, the acetylene black (electric conduction material) of 1 parts mass, and the polyvinylidene fluoride (PVDF) (binder) of 4 parts mass are dispersed in water, so as to provide slurry. The slurry is applied to the surface of the cathode current collector made from aluminum and having the size of 15 mm×15 mm×0.05 mm, so as to form the cathode active material layer. After drying, press molding is carried out, such that a cathode board is produced. The active material layer on the current collector has the value of 0.14 mg/mm² and the density of 2.0 g/cm³. The cathode board is cut into a predetermined size, and the electrode mixture is removed at a portion to be used as a lead tab weld part for taking out current, such that a sheet-shaped cathode is produced in which the cathode active material layer is formed on the cathode current collector.

In order to evaluate the cathode active material, a half cell (corresponding to CR 2032) is formed using. Li metal as opposite pole. Nonaqueous electrolysis solution is injected into this cell.

To evaluate the half cell, according to the embodiment and the comparative example, charging and discharging is performed three times under the condition of 1/10C and 2-4.5V, as a conditioning. Then, the charge capacity is measured on the condition of 1/10C, and the results are shown in Table A, Table B and Table C. The variation in the electric potential is measured while the capacity is measured relative to the test example 1-1 (comparative example) and the test example 2-1 (embodiment), and is shown in FIG. 3. As shown in FIG. 3, the excess voltage is decreased and the capacity is increased in the test example 2-1, compared with the test example 1-1, because impurities are removed effectively in the test example 2-1.

Table A evaluates the addition of the pH buffer solution at the time of synthesizing inorganic oxide (in the second process). Table B evaluates the pH buffer solution at the time of washing (in the fourth process). Table C evaluates the pH buffer solution at the synthesizing time and the washing time (in the second process and the fourth process).

TABLE A

| TEST | | | | MASS | 1/10C |
|---|---|---|---|---|---|
| EXAMPLE | ACTIVE | ADDITIVE | pH OF | CHANGE | CAPACITY |
| (TE) | MATERIAL | (BUFFER SOLUTION) | SLURRY | (G2 − G1) | (mAh/g) |
| 1-1 | LiMnPO₄ | NONE | 8.1 | 6.8 | 46 |
| 1-2 | LiMnPO₄ | Na₂HPO₄ + | 7.5 | 6.2 | 61 |
| | | NaH₂PO₄ | | | |
| 2-2 | LiMnPO₄ | CITRIC ACID + | 7 | 2.8 | 140 |
| | | SODIUM CITRATE | | | |
| 2-3 | LiMnPO₄ | CITRIC ACID + | 4.8 | 3.2 | 125 |
| | | SODIUM CITRATE | | | |

As shown in Table A, the capacity is increased by adding pH buffer solution at the synthesizing time (in the second process). Moreover, a comparison between the test example 1-2, the test example 2-2 and the test example 2-3 shows a remarkable improvement in the capacity when pH of the slurry after the synthesis is lower than or equal to 7.

TABLE B

| TEST | | | pH OF | MASS | 1/10C |
|---|---|---|---|---|---|
| EXAMPLE | ACTIVE | WASHING | WASHING | CHANGE | CAPACITY |
| (TE) | MATERIAL | SOLUTION | SOLUTION | (G2 − G1) | (mAh/g) |
| 1-1 | LiMnPO₄ | PURE WATER | 7 | 6.8 | 46 |
| 1-3 | LiMnPO₄ | Na₂CO₃ + | 10.2 | 5.4 | 60 |
| | | NaHCO₃ | | | |
| 1-4 | LiMnPO₄ | CITRIC ACID + | 3.6 | 3.3 | 55 |
| | | SODIUM CITRATE | | | |
| 2-4 | LiMnPO₄ | Na₂HPO₄ + NaH₂PO₄ | 4 | 3.3 | 120 |
| 2-5 | LiMnPO₄ | Na₂HPO₄ + NaH₂PO₄ | 5 | 3.4 | 131 |
| 2-6 | LiMnPO₄ | Na₂HPO₄ + NaH₂PO₄ | 6 | 3.5 | 128 |
| 2-7 | LiMnPO₄ | Na₂HPO₄ + NaH₂PO₄ | 7 | 3.3 | 127 |
| 2-8 | LiMnPO₄ | K₂HPO₄ + KH₂PO₄ | 5 | 3.8 | 124 |
| 2-9 | LiMnPO₄ | Na₂HPO₄ + NaH₂PO₄ + | 5.1 | 3.7 | 133 |
| | | MnSO₄ 0.1M | | | |
| 2-10 | LiMnPO₄ | Na₂HPO₄ + NaH₂PO₄ + | 5.2 | 3.8 | 134 |
| | | MnSO₄ 0.5M | | | |

As shown in Table B, sufficient capacity cannot be obtained in the test example 1-1 in which washing is performed with pure water without using pH buffer solution, because Li ion is dissolved into the pure water so as to exhibit alkalinity exceeding pH 7. When pH buffer solution with the buffer action of pH is used as washing solution, the capacity can be increased by controlling the pH of pH buffer solution in the range of 4-7 compared with a case where the pH is deviated from the range of 4-7. Moreover, the capacity can be further increased by making Mn ion to be contained based on the results of the test example 2-9 and the test example 2-10.

TABLE C

| TEST | | | | MASS | 1/10C |
|---|---|---|---|---|---|
| EXAMPLE | ACTIVE | | pH OF | CHANGE | CAPACITY |
| (TE) | MATERIAL | ADDITIVE | SLURRY | (G2 − G1) | (mAh/g) |
| 1-1 | LiMnPO₄ | NONE | 7.5 | 8 | 46 |
| 1-5 | LiFePO₄ | NONE | 7.2 | −3 | 145 |
| 1-6 | LiMn_{0.5}Fe_{0.5}PO₄ | NONE | 7.3 | −0.8 | 120 |
| 1-7 | LiMn_{0.8}Fe_{0.2}PO₄ | NONE | 7.3 | 5.1 | 95 |
| 2-1 | LiMnPO₄ | CITRIC ACID + | 6 | 2.5 | 145 |
| | | SODIUM CITRATE | | | |
| 2-11 | LiFePO₄ | CITRIC ACID + | 6 | −3.2 | 147 |
| | | SODIUM CITRATE | | | |
| 2-12 | LiMn_{0.5}Fe_{0.5}PO₄ | CITRIC ACID + | 6 | −1 | 146 |
| | | SODIUM CITRATE | | | |
| 2-13 | LiMn_{0.8}Fe_{0.2}PO₄ | CITRIC ACID + | 6 | 2.8 | 145 |
| | | SODIUM CITRATE | | | |

As shown in Table A, Table B, and Table C, when pH buffer solution is used in both of the synthesizing time and the washing time (in the second process and the fourth process), the capacity can be made high compared with the case where pH buffer solution is not at all used or is used only one of the synthesizing time and the washing time. Moreover, as shown in Table A, Table B, and Table C, when the capacity is high, for example, exceeds 100 mAh/g, the value of difference G2−G1 (mass change) is lower than or equal to 5%.

What is claimed is:

1. A cathode active material for a nonaqueous electrolyte secondary battery comprising:
a core part including an inorganic oxide having a polyanion structure, to which a carbon composite is possible; and
a shell part arranged to a surface of the core part, the shell part containing carbon, wherein
the inorganic oxide is LiₓMn_{y}M_{1-y}XO₄, in which
M is at least one of Co, Ni, Fe, Cu, Cr, Mg, Ca, Zn, and Ti,
X is at least one of P, As, Si, and Mo, and
0≦x<1.0 and 0.5≦y≦1.0,
the inorganic oxide has a maximum mass change ratio G1 in a temperature range from a room temperature to 250° C. when heated under inert atmosphere,
the inorganic oxide has a maximum mass change ratio G2 in a temperature range from 350° C. to 500° C. when heated under inert atmosphere, and
a difference between the maximum mass change ratio G2 and the maximum mass change ratio G1 is less than or equal to 5%.

2. A method of producing the cathode active material according to claim 1, wherein
synthesizing the inorganic oxide with a first pH buffer solution.

3. The method of producing the cathode active material according to claim 2, wherein
a slurry produced by the synthesizing of the inorganic oxide has pH lower than or equal to 7.0.

4. The method of producing the cathode active material according to claim 2, further comprising:
washing or wet-cracking the inorganic oxide with a second pH buffer solution after the synthesizing of the inorganic oxide.

5. The method of producing the cathode active material according to claim 4, wherein
the second pH buffer solution has pH in a range between 4.0 and 7.0.

6. The method of producing the cathode active material according to claim 5, wherein
the second pH buffer solution contains Mn ion.

7. The method of producing the cathode active material according to claim 2, wherein
the first pH buffer solution contains a weak acid and a sodium salt of the weak acid.

8. The method of producing the cathode active material according to claim 4, wherein
the inorganic oxide is synthesized and/or washed under a situation where pH is kept in a range higher than or equal to 4.0 and lower than or equal to 7.0.

9. A nonaqueous electrolyte secondary battery comprising the cathode active material according to claim 1.
